(19) United States
(12) Patent Application Publication
(10) Pub. No.: US 2026/0099687 A1
(43) Pub. Date: Apr. 9, 2026

(54) RADIO FREQUENCY IDENTIFICATION TAG IDENTIFIER FOR MOBILE UNIT

(71) Applicant: QUALCOMM Incorporated, San Diego, CA (US)

(72) Inventor: Robert Thomas FRANZO, Northport, MI (US)

(21) Appl. No.: 18/906,262

(22) Filed: Oct. 4, 2024

(51) Int. Cl. G06K 7/10

(52) U.S. Cl. CPC G06K 7/10386; G06K 7/10207; G06K 7/10346

(57) ABSTRACT

Various aspects of the present disclosure generally relate to wireless communication. In some aspects, a mobile unit (MU) may receive an ultra-high frequency (UHF) radio frequency identification (RFID) tag identifier that is uniquely associated with the MU. The MU may perform, responsive to receiving the UHF RFID tag identifier, one or more MU location operations. Numerous other aspects are described.

### FIELD OF THE DISCLOSURE

Aspects of the present disclosure generally relate to wireless communication and, for example, to radio frequency identification tag identifiers for mobile units.

### BACKGROUND

Radio frequency identification (RFID) refers to a technology that enables automated identification and/or tracking of RFID tags using wireless communications. For example, RFID tags may be attached to or embedded within objects to allow for tracking of the objects.

### SUMMARY

Some aspects described herein relate to an apparatus for wireless communication at a mobile unit (MU). The apparatus may include one or more memories and one or more processors coupled to the one or more memories. The one or more processors may be configured to cause the MU to receive an ultra-high frequency (UHF) radio frequency identification (RFID) tag identifier that is uniquely associated with the MU. The one or more processors may be configured to cause the MU to perform, responsive to receiving the UHF RFID tag identifier, one or more MU location operations.

Some aspects described herein relate to a method of wireless communication performed by a MU. The method may include receiving a UHF RFID tag identifier that is uniquely associated with the MU. The method may include performing, responsive to receiving the UHF RFID tag identifier, one or more MU location operations.

Some aspects described herein relate to an apparatus for wireless communication. The apparatus may include means for receiving a UHF RFID tag identifier that is uniquely associated with the apparatus. The apparatus may include means for performing, responsive to receiving the UHF RFID tag identifier, one or more MU location operations.

Some aspects described herein relate to a non-transitory computer-readable medium that stores a set of instructions for wireless communication by a MU. The set of instructions, when executed by one or more processors of the MU, may cause the MU to receive a UHF RFID tag identifier that is uniquely associated with the MU. The set of instructions, when executed by one or more processors of the MU, may cause the MU to perform, responsive to receiving the UHF RFID tag identifier, one or more MU location operations.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 shows a pictorial diagram of an example wireless communication environment, in accordance with the present disclosure.

FIG. 2 is a diagram illustrating example components of a device, in accordance with the present disclosure.

FIG. 3 is a diagram illustrating an example associated with radio frequency identification (RFID) tag identifiers for mobile units (MUs), in accordance with the present disclosure.

FIG. 4 is a block diagram illustrating an example associated with a system-on-chip RFID reader of an MU, in accordance with the present disclosure.

FIG. 5 is a flowchart of an example process associated with RFID tag identifiers for MUs, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Grocers, retailers, and other enterprises use mobile units (MUs), such as mobile handsets or mobile ultra-high-frequency (UHF) radio frequency identification (RFID) readers to read data from UHF RFID tags. For example, the UHF RFID tags may be attached to or embedded within objects, and the MUs may communicate with the UHF RFID tags to identify one or more characteristics of the goods. However, many such enterprises experience large quantities of missing (e.g., misplaced or purposely hidden) MUs. As a result, processing and memory resources of the missing MUs may be underutilized and/or unused. Additionally, or alternatively, the missing MUs may require excessive time and other resources to locate, which may decrease productivity and value while increasing costs associated with deploying MUs.

Some implementations described herein enable an RFID tag emulation mode and a tag identifier interrogation function for a UHF RFID mobile reader that is integrated into a trustworthy processing and communication platform of an MU. The RFID tag emulation mode may enable a missing MU to receive a tag identifier of the missing MU. Upon receiving the tag identifier, the missing MU may perform one or more operations that enable identification of a location of the missing MU. In some examples, the tag identifier may be a wake-on tag identifier that triggers the missing MU to wake up and service a wake-up event.

As a result, the RFID tag emulation mode may enable the missing MUs to be located, thereby improving processing and memory resource utilization of the missing MUs. Additionally, or alternatively, the RFID tag emulation mode may reduce time and other resources allocated to locating the missing MUs, which may increase productivity and value while decreasing costs associated with deploying MUs.

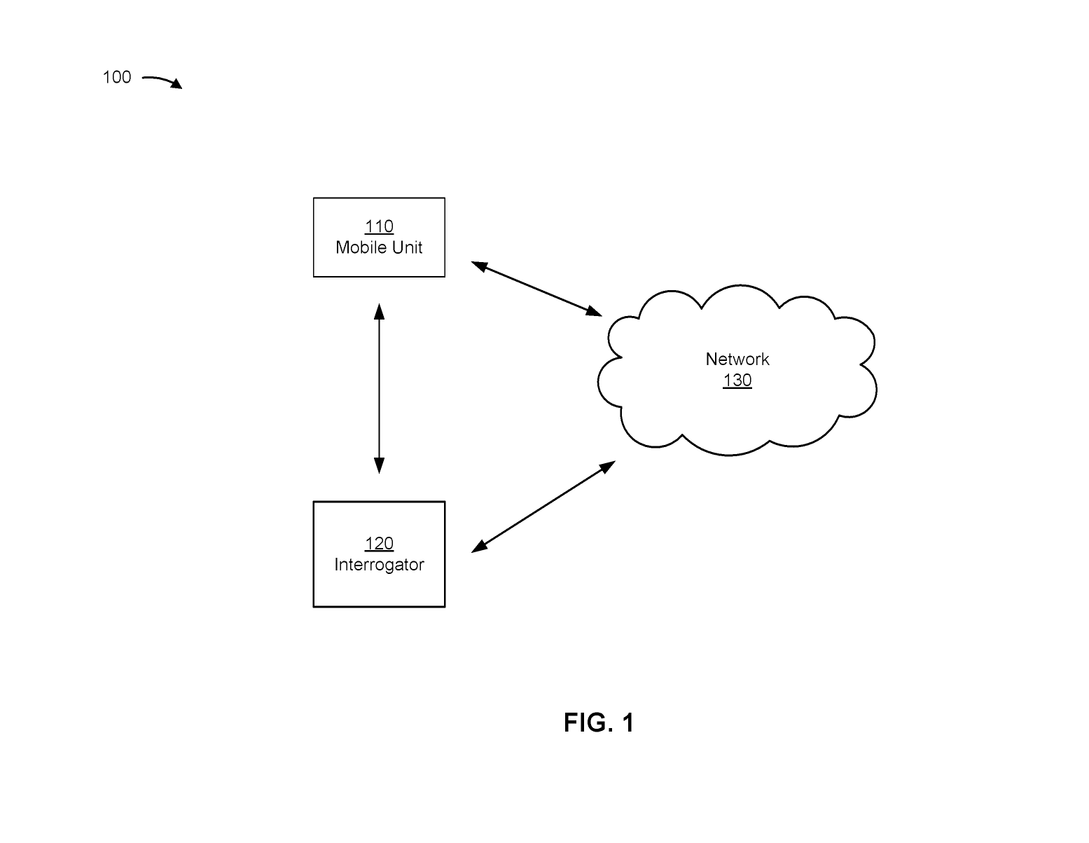

FIG. 1 shows a pictorial diagram of an example wireless communication environment 100. The wireless communication environment 100 may implement RFID technology, and may comprise a fixed indoor location (e.g., a warehouse, a factory, a store, or the like), a fixed outdoor location (e.g., a shipping yard, an agricultural field, or the like), or a mobile setting (e.g., a delivery vehicle, a conveyance, or the like).

In some examples, the wireless communication environment 100 may include an MU 110. The MU 110 may be a wireless communication device, such as a mobile handset, that has an integrated RFID reader. For example, the MU 110 may be capable of reading one or more RFID tags that may be present in the wireless communication environment 100. In some examples, the MU 110 may be a mobile UHF RFID reader (e.g., an RFID reader that operates at UHF frequencies, such as in Industrial, Scientific, and Medical (ISM) bands). In some examples, the one or more RFID tags may be UHF RFID tag(s) (e.g., RFID tag(s) that operate at UHF frequencies, such as in the ISM bands). In some examples, the wireless communication environment 100 may include multiple MUs 110.

In some examples, the wireless communication environment 100 may include an interrogator 120. The interrogator 120 may be capable of reading (or “interrogating”) one or more RFID tags that are present in the wireless communication environment 100. In some examples, the interrogator 120 may compliment the MU 110 by providing trustworthy location metadata (e.g., location information of the one or more RFID tags). In some examples, the interrogator 120 may be a UHF RFID reader and/or writer that includes a bidirectional electronically steerable phased array. The interrogator 120 may be suspended from a ceiling a given distance from the ground. The coverage area of the interrogator 120 may increase with the given distance from the ground. For example, the coverage area may be 650 square meters. In some examples, the interrogator 120 may be capable of performing a UHF RFID real-time location service (RTLS) of less than one meter. For example, the interrogator 120 may identify a location of an RFID tag to within one meter. In some examples, the interrogator 120 may support RFID tag programming, depending on RFID tag range and velocity. In some examples, the wireless communication environment 100 may include multiple interrogators 120.

In some examples, the wireless communication environment 100 may include a network 130. The network 130 may include one or more wired and/or wireless networks. For example, the network 130 may comprise a cellular network (e.g., a fifth generation (5G) network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 130 enables communication among the devices of wireless communication environment 100 and/or outside of wireless communication environment 100.

A tag (e.g., an RFID tag) and a reader (e.g., the MU 110 or the interrogator 120) may communicate using an interrogator-talks-first (ITF) scheme, whereby the tag backscatters modulated information in response to receiving a command from the reader. In some examples, the reader may code (e.g., encode or bit-code) information in reader-to-tag communications using pulse interval encoding (PIE). In some examples, the tag may code (e.g., encode or bit-code) information in tag-to-reader communications using a Miller-encoded subcarrier or bi-phase space coding (FM0). The tag and/or reader may modulate information using amplitude-shift keying (ASK).

The tag and/or reader may employ an anti-collision protocol, such as a slotted Aloha protocol. A slotted Aloha protocol (e.g., a Q-algorithm) is a multiple access protocol that uses a multi-point transmission channel and random access to reduce data loss during transmission (e.g., such that all terminals can access a medium without interfering with one another or colliding). A slotted Aloha protocol may operate at the data-link layer of the Open Systems Interconnection (OSI) model. In a first operation of the slotted Aloha protocol, each tag may receive a query and randomly select a slot in a frame to transmit a tag identifier. In a second operation of the slotted Aloha protocol, the tag(s) may transmit the tag identifier(s) during the selected slot(s). In a third operation of the slotted Aloha protocol, at the end of the frame, any tags that were successfully identified may cease participating in the slotted Aloha protocol. A fourth operation of the slotted Aloha protocol may resolve collisions by enabling any tags involved in a collision to repeat the slotted Aloha protocol in subsequent frames. Additionally, or alternatively, a transmitting node may retransmit a frame after a random delay if the transmitting node has not received an acknowledgment from a receiving node within a given amount of time after transmitting the frame.

The slotted Aloha procedure may differ from a pure Aloha procedure in several ways. In a pure Aloha procedure, any station can transmit data at any time; the slotted Ahola procedure may allow any station (e.g., a reader, an RFID tag, or the like) to transmit data at the beginning of any time slot. In the pure Aloha procedure, time is continuous and not globally synchronized; in the slotted Ahola procedure, time is discrete and globally synchronized. In the pure Aloha procedure, a vulnerable time may be equal to 2 × Tt, where Tt is an average transmission interval; in the slotted Ahola procedure, a vulnerable time may be equal to Tt. In the pure Aloha procedure, a probability of a successful transmission of a data packet may be equal to G × e⁻² G, where G is a rate of transmission attempts; in the slotted Ahola procedure, a probability of a successful transmission of a data packet may be equal to G × e⁻ G. In the pure Aloha procedure, a maximum efficiency may be 18.4%; in the slotted Ahola procedure, a maximum efficiency may be 36.8%. Additionally, or alternatively, the slotted Aloha procedure may halve a quantity of collisions and double an efficiency compared to the pure Aloha procedure.

In some examples, a reader may manage tag populations using three basic operations: a select operation, an inventory operation, and an access operation. The select operation may involve choosing a tag population. For example, the reader may use a select command to select one or more tags based at least in part on a value or values in a tag memory. Additionally, or alternatively, the reader may use a challenge command to challenge one or more tags based on tag support for a target cryptographic suite and/or authentication type. After performing the select operation, the reader may inventory the selected tag(s) using the inventory operation and/or access the selected tag(s) using the access operation.

The inventory operation may involve identifying individual tags. The inventory operation may occur in one or more inventory rounds. Each inventory round may operate in one session at a time. The reader may begin an inventory round by transmitting a query command in one of four sessions. One or more tags may reply to the query command. The reader may detect a single reply and request an identifier of the tag, such as an electronic product code (EPC), a global trade item number (GTIN), a serialized GTIN, or the like. The inventory operation may comprise multiple commands.

The access operation may involve communicating with an identified tag. For example, the reader may perform a core operation, such as reading a tag, writing to a tag, locking a tag, killing a tag, authenticating a tag (e.g., as part of a security-related operation), performing a file-related operation (e.g., opening a particular file in a user memory of the tag), or the like. The access operation may comprise multiple commands. In some examples, the reader may access tags that have been uniquely identified.

A tag may belong to a given class of tags (e.g., EPC UHF tag classes). Tags belonging to a read-only tag class (e.g., “class 0”) or an identity tag class (e.g., “class 1”) may have read-only memory and be passive (e.g., energy-harvesting-activated). Tags belonging to a high-functionality tag class (e.g., “class 2”) may have read and write memory (e.g., up to 65 kilobytes). Tags belonging to a semi-passive RFID tag class (e.g., “class 3”) may have read and write memory (e.g., up to 65 kilobytes) and a built-in battery to support increased read range. Tags belonging to an active tag class (e.g., “class 4”) may enable active communication, have a built-in battery to support increased read range, and be networked with other tags. Tags belonging to an active RFID tag class (e.g., “class 5”) may communicate with class 4 tags, other class 5 tags, and/or other devices.

In some examples, the MU 110 may enter various operating states. In an active operating state, a screen of the MU 110 may be on, and the MU 110 may be on and fully functional. In a doze operating state, the screen of the MU 110 may be off. The MU 110 may enter the operating state when the MU 110 is unplugged and stationary for a configurable length of time. While in the doze operating state, the MU 110 may restrict application access to a network and central processing unit (CPU) intensive services. The MU 110 may periodically exit the doze operating state, which may allow applications to complete deferred activities, and then re-enter the doze operating state at the end of a maintenance window. The MU 110 may exit the doze operating state when the user moves the MU 110, turns on the screen, or connects a charger.

In a sleep operating state, the screen of the MU 110 may be off, and the MU 110 may retain main power for an application processor (AP), which may enable a quick wake-up. During the sleep operating state, applications may be prohibited from accessing the network, alarms may be deferred, and Wi-Fi scans may be disabled. The MU 110 may periodically resume normal operations during a maintenance window, and then return to sleep for longer periods.

In a hibernation operating state, the screen of the MU 110 may be off, and the MU 110 may retain memory content and disable the main power. When the MU 110 is powered on, the AP may load the saved memory content. In a battery save application standby operating state, the screen of the MU 110 may be on, and the MU 110 may detect inactive applications and place the inactive applications in a standby mode until a user interacts with the inactive applications. During the battery save application standby operating state, applications may be prohibited from accessing the network more than once per day (e.g., synchronization operations and other tasks may be deferred). In a shutdown operating state, the screen of the MU 110 may be off, the battery level of the MU 110 may be below a battery level threshold (e.g., an original equipment manufacturer (OEM) configured level), the MU 110 may reserve battery, and a processor of the MU 110 may cold boot when powered on.

The number and arrangement of components shown in FIG. 1 are provided as an example. The wireless communication environment 100 may include additional components, fewer components, different components, or differently arranged components than those shown in FIG. 1. Additionally, or alternatively, a set of components (e.g., one or more components) of the wireless communication environment 100 may perform one or more functions described as being performed by another set of components of the wireless communication environment 100.

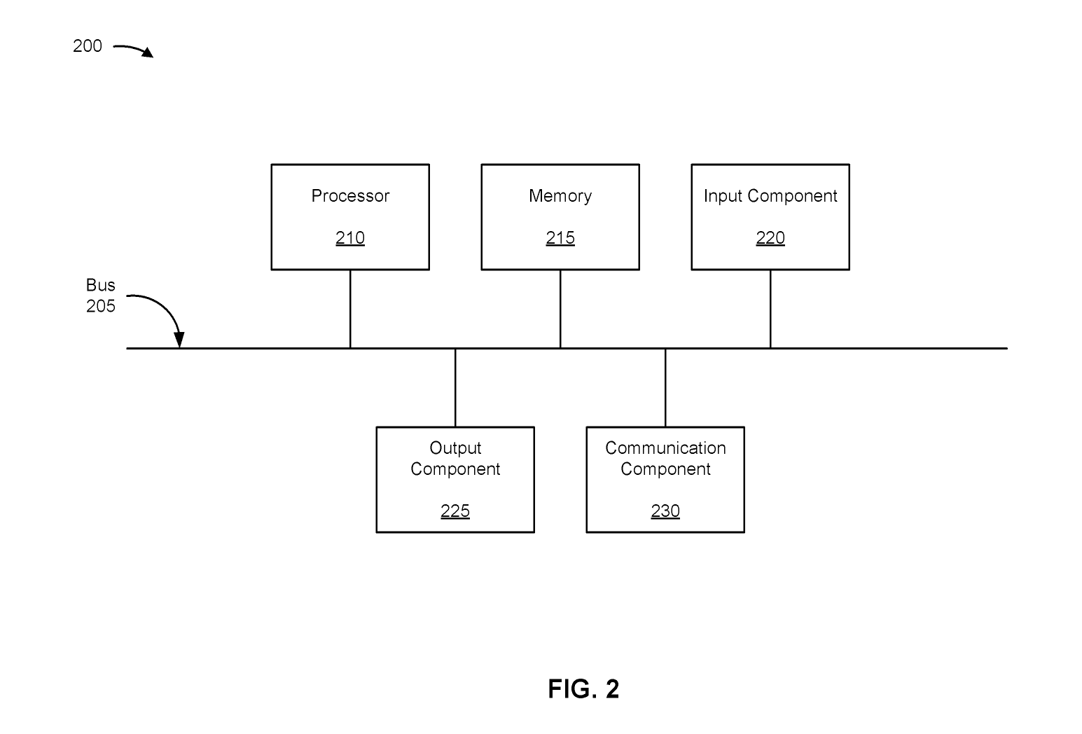

FIG. 2 is a diagram illustrating example components of a device 200, in accordance with the present disclosure. The device 200 may correspond to the MU 110 and/or the interrogator 120. In some aspects, MU 110 and/or the interrogator 120 may include one or more devices 200 and/or one or more components of the device 200. As shown in FIG. 2, the device 200 may include a bus 205, a processor 210, a memory 215, an input component 220, an output component 225, and/or a communication component 230.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for receiving a UHF RFID tag identifier that is uniquely associated with the MU; and/or means for performing, responsive to receiving the UHF RFID tag identifier, one or more MU location operations. In some aspects, the means for device 200 to perform processes and/or operations described herein may include one or more components of device 200 described in connection with FIG. 2, such as bus 205, processor 210, memory 215, input component 220, output component 225, and/or communication component 230.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

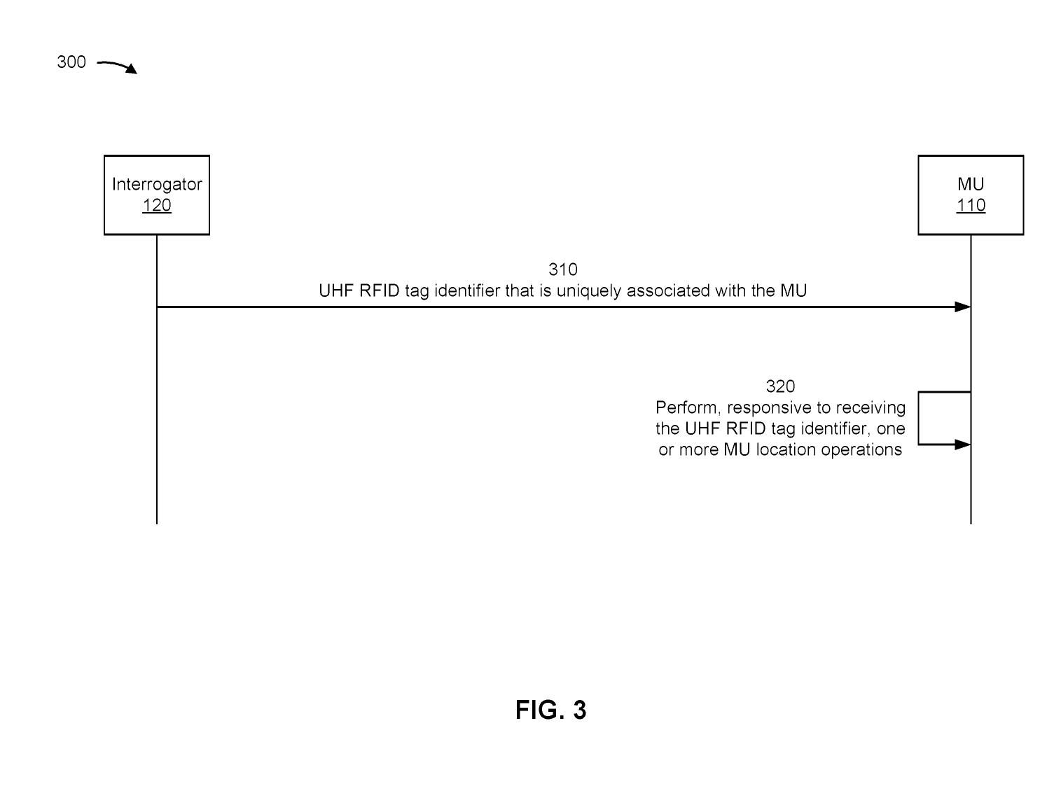

FIG. 3 is a diagram illustrating an example 300 associated with RFID tag identifiers for MUs, in accordance with the present disclosure. As shown in FIG. 3, an MU 110 and an interrogator 120 may communicate with one another. In some examples, the MU 110 may emulate a tag.

In some aspects, the MU 110 may be operable in a passive mode. In passive mode, the MU 110 supports minimal functionality (e.g., power-constrained operations). In some aspects, the passive mode may include a battery depleted passive mode. For example, the MU 110 may operate in the battery depleted passive mode while a battery level of the MU 110 does not satisfy (e.g., is less than) a battery level threshold. In the battery depleted passive mode, the MU 110 may perform operations that require no battery charge, such as passive energy harvesting tag operations. In some examples, the battery depleted passive mode may include a shutdown operating state, as discussed above in connection with FIG. 1.

In some aspects, the MU 110 may be operable in an active mode. In active mode, the MU 110 supports full or partial functionality (e.g., more than minimal functionality). In some aspects, the active mode may include a battery charged active mode. For example, the MU 110 may operate in the battery charged active mode while the battery level of the MU 110 satisfies (e.g., is greater than or equal to) the battery level threshold. In the active mode, the MU 110 may perform operations that require battery charge. In some examples, the active mode may include an active operating state, a doze operating state, a sleep operating state, a hibernation operating state, or a battery save application standby operating state, as discussed above in connection with FIG. 1. In some aspects, the active mode may include a battery residual active mode. In the battery residual active mode, the MU 110 may perform operations that require residual battery capacity. For example, the MU 110 may perform a subset of the operations that the MU 110 can perform while in the battery charged active mode. For example, in the battery residual active mode, the MU 110 may perform a subset of operations associated with an active operating state, a doze operating state, a sleep operating state, a hibernation operating state, or a battery save application standby operating state, as discussed above in connection with FIG. 1.

As shown by reference number 310, the interrogator 120 may transmit, and the MU 110 may receive, a UHF RFID tag identifier that is uniquely associated with the MU 110. In some examples, a location of the MU 110 may be unknown, and the interrogator 120 may search for the MU 110 by broadcasting the UHF RFID tag identifier. The UHF RFID tag identifier may be any suitable identifier of the MU 110, such as a tag address (e.g., an EPC). In some examples, the UHF RFID tag identifier may be assigned to the MU 110. The UHF RFID tag identifier may be “UHF” in that a wireless communication that conveys the UHF RFID tag identifier may be in a UHF spectrum (e.g., 300 megahertz – 3 gigahertz). For example, the wireless communication may be a far-field communication. The UHF RFID tag identifier may be uniquely associated with the MU 110 in that the UHF RFID tag identifier may uniquely identify the MU 110. For example, the UHF RFID tag identifier may be globally unique or locally unique (e.g., unique within a network to which the MU 110 belongs).

In some aspects, receiving the UHF RFID tag identifier may include receiving an access command. For example, the UHF RFID tag identifier may be included in an access command that is transmitted as part of an access operation, as discussed above in connection with FIG. 1. For example, the interrogator 120 may access the MU 110 using the UHF RFID tag identifier.

In some aspects, receiving the UHF RFID tag identifier may include receiving a select command. For example, the UHF RFID tag identifier may be included in a select command that is transmitted as part of a select operation (e.g., a select operation sequence), as discussed above in connection with FIG. 1.

In some aspects, the MU 110 may receive the RFID tag identifier from an interrogator (e.g., the interrogator 120) that performed an inventory of the UHF RFID tag identifier. For example, the interrogator 120 may have previously performed an inventory operation of tag addresses (as discussed above in connection with FIG. 1) and, as part of the inventory operation, received and stored the UHF RFID tag identifier of the MU 110.

In some aspects, the UHF RFID tag identifier may correspond to a match address associated with a vectored interrupt. In some examples, the match address may be assigned to the MU 110, and may persist in memory of the MU 110 in any mode (e.g., in the active mode or the passive mode). For example, the MU 110 may store the match address in non-volatile memory. The match address may be associated with a vectored interrupt in that the match address may indicate a vector associated with the vectored interrupt. The vectored interrupt may be an interrupt that is executed by the MU 110 based at least in part on the vector. The vector may be associated with the vectored interrupt in that the vector may indicate an interrupt routine (e.g., an MU programmed interrupt routine) that is to be executed by the MU 110 as part of the vectored interrupt. For example, the vector may indicate an offset from a base address. In some examples, the match address may support a function vector.

In some aspects, the interrogator 120 may transmit, and the MU 110 may receive, the vector associated with the vectored interrupt. In some examples, the vector may be included in a wireless communication as part of a command or data. For example, the vector may be included in a payload of a wireless communication, such as an inventory command.

As shown by reference number 320, the MU 110 may perform, responsive to receiving the UHF RFID tag identifier, one or more MU location operations. The one or more MU location operations may include operations that indicate, or enable identification of, a location of the MU 110. For example, the location of the MU 110 may be identified using a global navigation satellite system (GNSS), Wi-Fi, Bluetooth, ultra-wideband (UWB), relative dead reckoning, or the like. In some examples, after the location of the MU 110 has been identified, the MU 110 may indicate the location of the MU 110 via one or more communication channels, such as cellular, wide area network (WAN), Wi-Fi, Bluetooth, UWB, or the like.

In some aspects, performing the one or more MU location operations may include passively transmitting a response to the UHF RFID tag identifier. The MU 110 may “passively” transmit the response in that the MU 110 may transmit the response without using stored battery charge. For example, the MU 110 may harvest energy from a transmission (e.g., from the wireless communication that conveys the UHF RFID tag identifier) and backscatter the transmission using the harvested energy. In this example, the backscattered transmission may be the response. Thus, for example, the MU 110 may passively process and acknowledge reception of the UHF RFID tag identifier (and/or the match address). The MU 110 may passively transmit the response in any mode (e.g., in the active mode or the passive mode).

In some aspects, the response may be associated with one or more interrogator RTLS capabilities. The one or more interrogator RTLS capabilities may include one or more capabilities (e.g., functionalities or operations) of the interrogator 120 for RTLS (e.g., for identifying the location of the MU 110). The response may be associated with the one or more interrogator RTLS capabilities in that the interrogator 120 can use the response to perform RTLS. For example, the interrogator 120 may use the response to identify the location of the MU 110 (e.g., by performing triangulation, trilateralization, or the like).

In some aspects (e.g., where the MU 110 is operable in the active mode), the one or more MU location operations may include performing a wake-up operation. The wake-up operation may be an operation whereby the MU 110 enters a higher mode of operation that uses more battery charge. For example, the MU 110 may service an interrupt routine (e.g., a wake-up event interrupt routine) corresponding to the UHF RFID tag identifier (e.g., a wake-on tag identifier). For example, a vectored interrupt (e.g., a wake-up vectored interrupt) may initiate execution of various support services, such as use cases for identifying the location of the MU 110 and/or use cases where the screen of the MU 110 is off (e.g., because the MU 110 is in a doze operating state, a sleep operating state, or a hibernation operating state) and the MU 110 is triggered to wake up and service a wake-up event.

In some aspects (e.g., where the MU 110 is operable in the active mode), the MU 110 may receive a plurality of UHF RFID tag identifiers uniquely associated with the MU 110. In some examples, the UHF RFID tag identifiers may correspond to respective match addresses. For example, the match addresses may trigger the MU 110 to generate an audible signal (e.g., via a speaker of the MU 110), generate a visible light signal (e.g., a flashing light, a light generated by a light-emitting diode (LED) of the MU 110, a light generated by a flashlight of the MU 110, and/or the like), activate a camera of the MU 110 and stream a video from the camera, or the like. Thus, for example, the UHF RFID tag identifiers may enable a plurality of MU location operations (e.g., additional vectored wake-up events).

As indicated above, FIG. 3 is provided as an example. Other examples may differ from what is described with respect to FIG. 3.

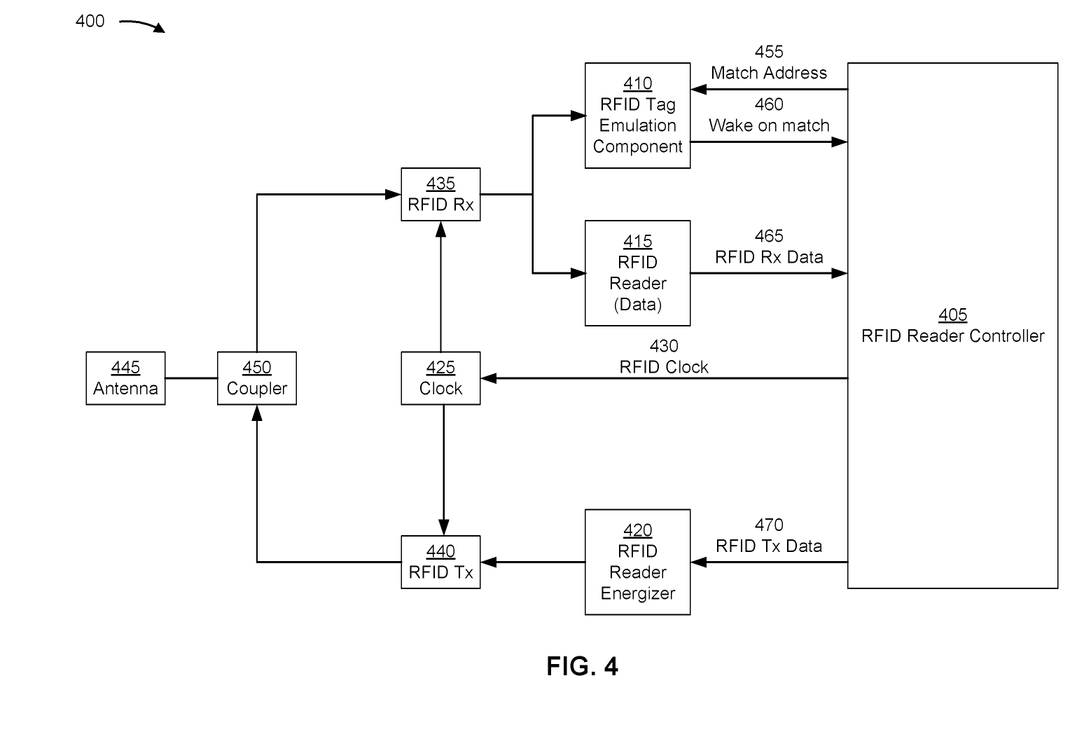

FIG. 4 is a block diagram illustrating an example 400 associated with a system-on-chip (SOC) RFID reader of the MU 110, in accordance with the present disclosure. In some examples, the SOC RFID reader (e.g., a UHF RFID mobile interrogator or reader) may be a trustworthy processing and communication platform integrated with the MU 110 that is capable of performing RFID tag emulation.

The SOC RFID reader may include an RFID reader controller 405. The RFID reader controller 405 may be responsible for managing RFID reader functionality of the MU 110, including RFID tag emulation. The RFID reader controller 405 may communicate with an RFID tag emulation component 410, an RFID reader 415, and an RFID reader energizer component 420. The RFID tag emulation component 410 may enable the MU 110 to enter an RFID tag emulation mode in which the MU 110 may perform the RFID tag emulation. The RFID reader 415 may identify data from a received signal, and the RFID reader energizer component 420 may provide energy for data transmission.

The RFID reader controller 405 may also communicate with a clock 425. For example, as shown by reference number 430, the RFID reader controller 405 may transmit an RFID clock signal to the clock 425. The clock 425 may maintain a timing synchronization between an RFID receive component 435 and an RFID transmit component 440. The RFID receive component 435 may receive signals from an antenna 445 via a coupler 450, and the RFID transmit component 440 may transmit signals to the antenna 445 via the coupler 450.

As shown by reference number 455, the RFID reader controller 405 may program (e.g., configure, assign, or the like) the RFID tag emulation component 410 with one or more match addresses. For example, the RFID reader controller 405 may program the match address(es) in cases where the MU 110 is operable in an active mode. In some examples, the RFID reader controller 405 may program the match address(es) upon boot-up of the MU 110. In some examples, the match address(es) may uniquely correspond to one or more UHF RFID tag identifiers of the MU 110.

In some examples, the RFID receive component 435 may receive (via the antenna 445 and the coupler 450) a signal that includes the UHF RFID tag identifier. The RFID receive component 435 may transmit the signal to the RFID tag emulation component 410 and/or the RFID reader 415. As shown by reference number 460, the RFID tag emulation component 410 may transmit a wake on match indication to the RFID reader controller. A wake on match indication may trigger a wake-up, and may be transmitted in response to identifying a match address based at least in part on the UHF RFID tag identifier. As shown by reference number 465, the RFID reader 415 may transmit RFID data conveyed by the received signal.

As shown by reference number 470, the RFID reader controller 405 may transmit RFID data (e.g., via the RFID reader energizer 420, the RFID transmit component 440, the coupler 450, and the antenna 445). For example, the RFID reader controller 405 may passively transmit a response to the UHF RFID tag identifier.

As indicated above, FIG. 4 is provided as an example. Other examples may differ from what is described with respect to FIG. 4.

Performing the one or more MU location operations responsive to receiving the UHF RFID tag identifier may enable the MU 110 to be located, thereby improving processing and memory resource utilization of the MU 110. Additionally, or alternatively, the RFID tag emulation mode may reduce time and other resources allocated to locating the MU 110, which may increase productivity and value while decreasing costs associated with deploying MUs.

Receiving the UHF RFID tag identifier from an interrogator that performed an inventory of the UHF RFID tag identifier may help to conserve interrogator resources. For example, in cases where a plurality of interrogators are deployed throughout the wireless communication environment 100, the UHF RFID tag identifier may be transmitted by only the interrogator that previously performed the inventory of the UHF RFID tag identifier (e.g., because the MU 110 may still be within range of that interrogator), so that the other interrogators (and associated interrogator resources) need not be diverted to locating the MU 110.

Receiving the plurality of UHF RFID tag identifiers uniquely associated with the MU 110 may help to further improve processing and memory resource utilization of the MU 110 and/or to reduce resources occupied by locating the MU 110. For example, the pluralities of UHF RFID tag identifiers may correspond to respective MU location operations, thereby enabling the MU 110 to be located more efficiently (e.g., faster and/or using fewer resources).

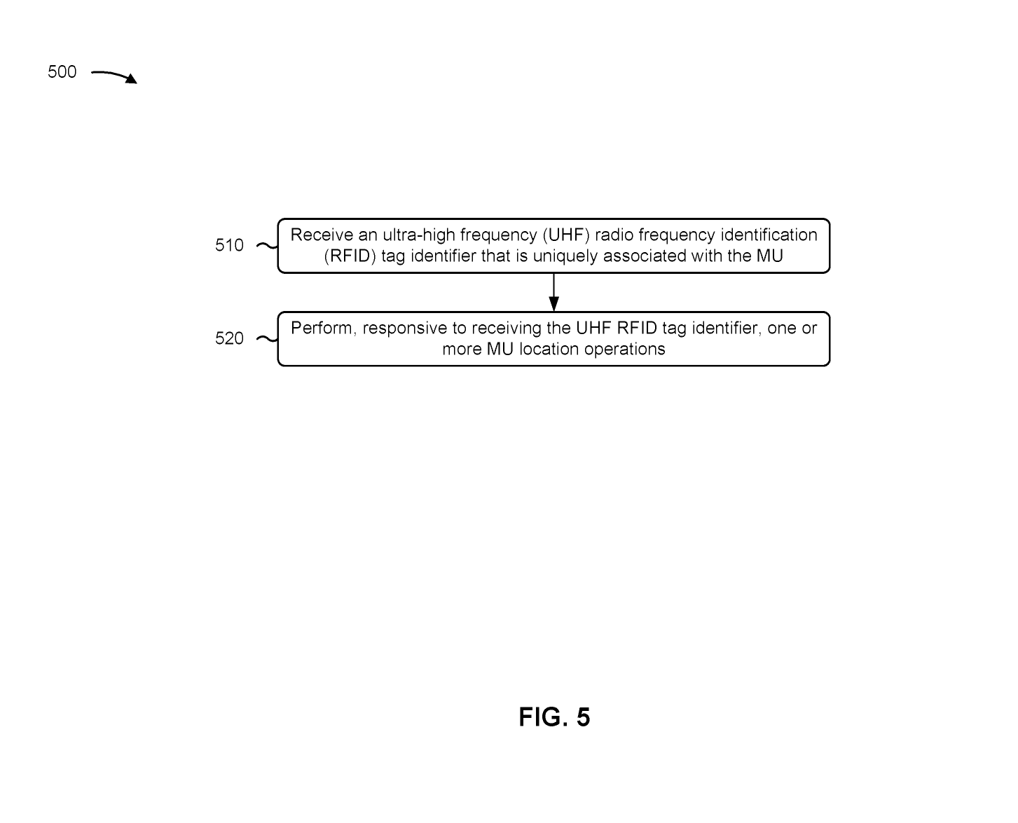

FIG. 5 is a flowchart of an example process 500 associated with RFID tag identifiers for MUs. In some implementations, one or more process blocks of FIG. 5 are performed by a MU (e.g., MU 110). In some implementations, one or more process blocks of FIG. 5 are performed by another device or a group of devices separate from or including the MU, such as an interrogator (e.g., interrogator 120) and/or a network (e.g., network 130). Additionally, or alternatively, one or more process blocks of FIG. 5 may be performed by one or more components of device 200, such as bus 205, processor 210, memory 215, input component 220, output component 225, and/or communication component 230.

As shown in FIG. 5, process 500 may include receiving an UHF RFID tag identifier that is uniquely associated with the MU (block 510). For example, the MU may receive an UHF RFID tag identifier that is uniquely associated with the MU, as described above.

As further shown in FIG. 5, process 500 may include performing, responsive to receiving the UHF RFID tag identifier, one or more MU location operations (block 520). For example, the MU may perform, responsive to receiving the UHF RFID tag identifier, one or more MU location operations, as described above.

Process 500 may include additional implementations, such as any single implementation or any combination of implementations described below and/or in connection with one or more other processes described elsewhere herein.

In a first implementation, performing the one or more MU location operations include passively transmitting a response to the UHF RFID tag identifier.

In a second implementation, alone or in combination with the first implementation, the response is associated with one or more interrogator RTLS capabilities.

In a third implementation, alone or in combination with one or more of the first and second implementations, receiving the UHF RFID tag identifier comprises receiving an access command.

In a fourth implementation, alone or in combination with one or more of the first through third implementations, receiving the UHF RFID tag identifier comprises receiving a select command.

In a fifth implementation, alone or in combination with one or more of the first through fourth implementations, receiving the UHF RFID tag identifier includes receiving the UHF RFID tag identifier from an interrogator that performed an inventory of the UHF RFID tag identifier.

In a sixth implementation, alone or in combination with one or more of the first through fifth implementations, the UHF RFID tag identifier corresponds to a match address associated with a vectored interrupt.

In a seventh implementation, alone or in combination with one or more of the first through sixth implementations, process 500 includes receiving a vector associated with the vectored interrupt.

In an eighth implementation, alone or in combination with one or more of the first through seventh implementations, the MU is operable in a passive mode.

In a ninth implementation, alone or in combination with one or more of the first through eighth implementations, the passive mode includes a battery depleted passive mode.

In a tenth implementation, alone or in combination with one or more of the first through ninth implementations, the MU is operable in an active mode.

In an eleventh implementation, alone or in combination with one or more of the first through tenth implementations, the one or more MU location operations include performing a wake-up operation.

In a twelfth implementation, alone or in combination with one or more of the first through eleventh implementations, receiving the UHF RFID tag identifier comprises receiving a plurality of UHF RFID tag identifiers uniquely associated with the MU.

In a thirteenth implementation, alone or in combination with one or more of the first through twelfth implementations, the active mode includes a battery charged active mode.

In a fourteenth implementation, alone or in combination with one or more of the first through thirteenth implementations, the active mode includes a battery residual active mode.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method of wireless communication performed by a mobile unit (MU), comprising: receiving an ultra-high frequency (UHF) radio frequency identification (RFID) tag identifier that is uniquely associated with the MU; and performing, responsive to receiving the UHF RFID tag identifier, one or more MU location operations.

Aspect 2: The method of Aspect 1, wherein performing the one or more MU location operations include passively transmitting a response to the UHF RFID tag identifier.

Aspect 3: The method of Aspect 2, wherein the response is associated with one or more interrogator real-time location service (RTLS) capabilities.

Aspect 4: The method of any of Aspects 1-3, wherein receiving the UHF RFID tag identifier comprises receiving an access command.

Aspect 5: The method of any of Aspects 1-4, wherein receiving the UHF RFID tag identifier comprises receiving a select command.

Aspect 6: The method of any of Aspects 1-5, wherein receiving the UHF RFID tag identifier includes receiving the UHF RFID tag identifier from an interrogator that performed an inventory of the UHF RFID tag identifier.

Aspect 7: The method of any of Aspects 1-6, wherein the UHF RFID tag identifier corresponds to a match address associated with a vectored interrupt.

Aspect 8: The method of Aspect 7, further comprising: receiving a vector associated with the vectored interrupt.

Aspect 9: The method of any of Aspects 1-8, wherein the MU is operable in a passive mode.

Aspect 10: The method of Aspect 9, wherein the passive mode includes a battery depleted passive mode.

Aspect 11: The method of any of Aspects 1-10, wherein the MU is operable in an active mode.

Aspect 12: The method of Aspect 11, wherein the one or more MU location operations include performing a wake-up operation.

Aspect 13: The method of Aspect 11, wherein receiving the UHF RFID tag identifier comprises receiving a plurality of UHF RFID tag identifiers uniquely associated with the MU.

Aspect 14: The method of Aspect 11, wherein the active mode includes a battery charged active mode.

Aspect 15: The method of Aspect 11, wherein the active mode includes a battery residual active mode.

Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 17: An apparatus for wireless communication at a device, the apparatus comprising one or more memories and one or more processors coupled to the one or more memories, the one or more processors configured to cause the device to perform the method of one or more of Aspects 1-15.

Aspect 18: An apparatus for wireless communication, the apparatus comprising at least one means for performing the method of one or more of Aspects 1-15.

Aspect 19: A non-transitory computer-readable medium storing code for wireless communication, the code comprising instructions executable by one or more processors to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

Aspect 21: A device for wireless communication, the device comprising a processing system that includes one or more processors and one or more memories coupled with the one or more processors, the processing system configured to cause the device to perform the method of one or more of Aspects 1-15.

Aspect 22: An apparatus for wireless communication at a device, the apparatus comprising one or more memories and one or more processors coupled to the one or more memories, the one or more processors individually or collectively configured to cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a mobile unit (MU), comprising:
one or more memories; and
one or more processors, coupled to the one or more memories, configured to cause the MU to:
receive an ultra-high frequency (UHF) radio frequency identification (RFID) tag identifier that is uniquely associated with the MU; and
perform, responsive to receiving the UHF RFID tag identifier, one or more MU location operations.

2. The apparatus of claim 1, wherein the one or more processors, to cause the MU to perform the one or more MU location operations, are configured to cause the MU to passively transmit a response to the UHF RFID tag identifier.

3. The apparatus of claim 2, wherein the response is associated with one or more interrogator real-time location service (RTLS) capabilities.

4. The apparatus of claim 1, wherein the one or more processors, to cause the MU to receive the UHF RFID tag identifier, are configured to cause the MU to receive an access command.

5. The apparatus of claim 1, wherein the one or more processors, to cause the MU to receive the UHF RFID tag identifier, are configured to cause the MU to receive a select command.

6. The apparatus of claim 1, wherein the one or more processors, to cause the MU to receive the UHF RFID tag identifier, are configured to cause the MU to receive the UHF RFID tag identifier from an interrogator that performed an inventory of the UHF RFID tag identifier.

7. The apparatus of claim 1, wherein the UHF RFID tag identifier corresponds to a match address associated with a vectored interrupt.

8. The apparatus of claim 7, wherein the one or more processors are further configured to cause the MU to:
receive a vector associated with the vectored interrupt.

9. The apparatus of claim 1, wherein the MU is operable in a passive mode.

10. The apparatus of claim 9, wherein the passive mode includes a battery depleted passive mode.

11. The apparatus of claim 1, wherein the MU is operable in an active mode.

12. The apparatus of claim 11, wherein the one or more processors are further configured to cause the MU to perform a wake-up operation.

13. The apparatus of claim 11, wherein the one or more processors, to cause the MU to receive the UHF RFID tag identifier, are configured to cause the MU to receive a plurality of UHF RFID tag identifiers uniquely associated with the MU.

14. The apparatus of claim 11, wherein the active mode includes a battery charged active mode.

15. The apparatus of claim 11, wherein the active mode includes a battery residual active mode.

16. A method of wireless communication performed by a mobile unit (MU), comprising:
receiving an ultra-high frequency (UHF) radio frequency identification (RFID) tag identifier that is uniquely associated with the MU; and
performing, responsive to receiving the UHF RFID tag identifier, one or more MU location operations.

17. The method of claim 16, wherein performing the one or more MU location operations include passively transmitting a response to the UHF RFID tag identifier.

18. The method of claim 16, wherein receiving the UHF RFID tag identifier comprises receiving an access command.

19. An apparatus for wireless communication, comprising:
means for receiving an ultra-high frequency (UHF) radio frequency identification (RFID) tag identifier that is uniquely associated with the apparatus; and
means for performing, responsive to receiving the UHF RFID tag identifier, one or more MU location operations.

20. The apparatus of claim 19, wherein the means for performing the one or more MU location operations include means for passively transmitting a response to the UHF RFID tag identifier.
